(19) United States
(12) Patent Application Publication
(10) Pub. No.: US 2015/0229038 A1
(43) Pub. Date: Aug. 13, 2015

(54) MALE TERMINAL

(71) Applicant: YAZAKI CORPORATION, Tokyo (JP)

(72) Inventors: Naokazu NAGASAKA, Shizuoka (JP); Toshinobu TSUSHIMA, Shizuoka (JP)

(21) Appl. No.: 14/696,526

(22) Filed: Apr. 27, 2015

Related U.S. Application Data
(63) Continuation of application No. PCT/JP2013/076563, filed on Sep. 30, 2013.

(30) Foreign Application Priority Data
Nov. 7, 2012 (JP) 2012-245120

(51) Int. Cl. H01R 4/18

(52) U.S. Cl. CPC H01R 4/184

(57) ABSTRACT

A mail terminal has a tab section formed by bending and folding back a plate-like base material on itself. The tab section has a first flat plate section, a fold section which is formed at a side end of the first flat plate section by bending, and a second flat plate section which is extended from a side end of the fold section and which is superposed on the first flat plate section. At least one of the first flat plate section and the second flat plate section has a depressedly deformed section provided at the side end thereof which is located on the side opposite the fold section. The depressedly deformed section is depressed on the outer surface side and protrudes on the inner surface side.

### CROSS REFERENCE OF THE RELATED APPLICATION

This application is a continuation of PCT Application No. PCT/JP2013/076563, filed on Sep. 30, 2013, and claims the priority of Japanese Patent Application No. 2012-245120, filed on Nov. 7, 2012, the content of both of which is incorporated herein by reference.

### TECHNICAL FIELD

The present invention relates to a male terminal to be electrically connected to a female terminal.

### BACKGROUND ART

Some male terminals include a tab portion (rod portion) to be fitted into a female terminal, and the tab portion is formed by bending a plate-shaped base material in a folded-back manner (Japanese Patent Application Publications No. 2001-266988, No. 2010-102831, and No. Hei 9-223532). FIGS. 1A and 1B show a first conventional example of a male terminal of this type. This male terminal 50A is formed by bending a predetermined-shaped base material made of a plate-shaped electrically-conductive metal. The male terminal 50A includes: a tab portion 51 to be connected to a female terminal; an electrical cable crimping portion 52 to which an electrical cable (not illustrated) is connected; and an intermediate linking portion 53 linking the tab portion 51 and the electrical cable crimping portion 52.

The electrical cable crimping portion 52 includes: a pair of conductor pinching portions 52a and a pair of cover pinching portions 52b. The electrical cable (not illustrated) is fixedly crimped to the electrical cable crimping portion 52.

As shown in FIG. 1B in detail, the tab portion 51 includes: a first flat plate portion 60; a folded-back portion 61 bent from a side end of the first flat plate portion 60; and a second flat plate portion 62 extended from a side end of the folded-back portion 61, and overlapping the first flat plate portion 60. A clearance d of a predetermined dimension is formed between the first flat plate portion 60 and the second flat plate portion 62. By providing the clearance d of the predetermined dimension, a tab thickness c of the tab portion 51 is set at a predetermined dimension (c=2b+d, where b denotes a plate thickness of the base material).

FIGS. 2A and 2B show a male terminal 50B as a second conventional example. The configuration of the tab portion 51 makes the male terminal 50B different from that as the first conventional example. As shown in FIG. 2B in detail, the tab portion 51 includes: a first flat plate portion 70; a pair of folded-back portions 71 respectively bent from two side ends of the first flat plate portion 70; and a pair of second flat plate portions 72 extended from side ends of the respective folded-back portions 71, and overlapping the first flat plate portion 70. A clearance d of a predetermined dimension is formed between the first flat plate portion 70 and the second flat plate portions 72. By providing the clearance d of the predetermined dimension, the tab thickness c of the tab portion 51 is set at a predetermined dimension (c=2b+d, where b denotes the plate thickness of the base material). Incidentally, components which are identical to those of the first conventional example will be omitted from descriptions, and will be denoted by the same reference signs in FIG. 2A for clarification purpose.

The first and second conventional examples can make their tab portions 51 stronger than strength corresponding to the plate thickness b of the base material, since their tab portions 51 each have a structure in which the two base materials are stacked. In addition, since the clearance d is formed between the first flat plate portion 60, 70 and the second flat plate portion 62, 72, the desired tab thickness c in a dimensional range slightly larger than the double of the plate thickness b of the base material can be achieved without changing the plate thickness b of the base material.

### CITATION LIST

### Patent Literature

### [PTL 1] Japanese Patent Application Publication No. 2001-266988

### [PTL 2] Japanese Patent Application Publication No. 2010-102831

[PTL 3] Japanese Patent Application Publication No. Hei 9-223532

### SUMMARY

In the first and second conventional examples, however, the dimension of the clearance between the first flat plate portion 60, 70 and the second flat plate portion 62, 72 varies depending on a folded-back angle (degree) at which the folded-back portions 61, 71 are folded back. To put it concretely, if the folded-back angle of the folded-back portions 61, 71 is smaller than a predetermined folded-back angle, the tab thickness c (particularly, the tab thickness at the opposite side edge position of the tab from the folded-back portions 61, 71) becomes larger, and force needed for insertion into the female terminal (not illustrated) increases. If the folded-back angle of the folded-back portions 61, 71 is larger than a predetermined folded-back angle (if the folded-back portions 61, 71 are folded back too much), the tab thickness c (particularly, the tab thickness at the opposite side edge position of the tab from the folded-back portions 61, 71) becomes smaller, load of contact between the tab portion and the female terminal (not illustrated) becomes smaller.

The present invention has been made in order to solve the foregoing problem. An object of the present invention is to provide a male terminal which enables the tab thickness to be accurately set at a desired thickness.

An aspect of the present invention provides a male terminal characterized as follows. The male terminal includes a tub portion formed by bending a plate-shaped base material in a folded-back manner. The tab portion includes: a first flat plate portion; a folded-back portion bent from a side end of the first flat plate portion; and a second flat plate portion extended from a side end of the folded-back portion, and overlapping the first flat plate portion. At least one of the first flat plate portion and the second flat plate portion includes a depressedly deformed portion in an opposite side end portion thereof from the folded-back portion, the depressedly deformed portion depressed from outside and project inward. A projecting portion on an inner surface of the depressedly deformed portion is in contact with the second flat plate portion or the first flat plate portion.

The depressedly deformed portion may be provided in a non-contact area which remains out of contact with a female terminal when the tab portion is fitted into the female terminal. The depressedly deformed portions may be respectively provided in two places outside a contact area which comes into contact with the female terminal when the male terminal is fitted into the female terminal.

According to the aspect of the present invention, because a clearance between the first flat plate portion and the second flat plate portion can be set at an accurate dimension, and because a tab thickness can be accurately set at a desired thickness, it is possible to securely prevent problems which would occur if the tab thickness were thicker or thinner than the desired thickness. Since the depressedly deformed portions are provided by deforming one of the flat plate portions, the provision of the depressedly deformed portions can be achieved by using the base material whose dimension is the same as that of a base material which would be used if no depressedly deformed portions were provided, and thus does not increase material costs. Since the depressedly deformed portions are provided at positions in the opposite side end of the one of the flat plate portions from the folded-back portion, the dimension of the clearance between the first flat plate portion and the second flat plate portion can be set most accurately.

### BRIEF DESCRIPTION OF DRAWINGS

FIG. 1A is a perspective view of a male terminal of a first conventional example.

FIG. 1B is a cross-sectional view of the male terminal taken along the 1B-1B line of FIG. 1A.

FIG. 2A is a perspective view of a male terminal of a second conventional example.

FIG. 2B is a cross-sectional view of the male terminal taken along the 2B-2B line of FIG. 2A.

FIG. 3A is a perspective view of a male terminal according to an embodiment of the present invention.

FIG. 3B is a cross-sectional view of the male terminal taken along the 3B-3B line of FIG. 3A.

FIG. 4 shows the embodiment of the present invention, and is a perspective view of a main part of a tab portion of the male terminal.

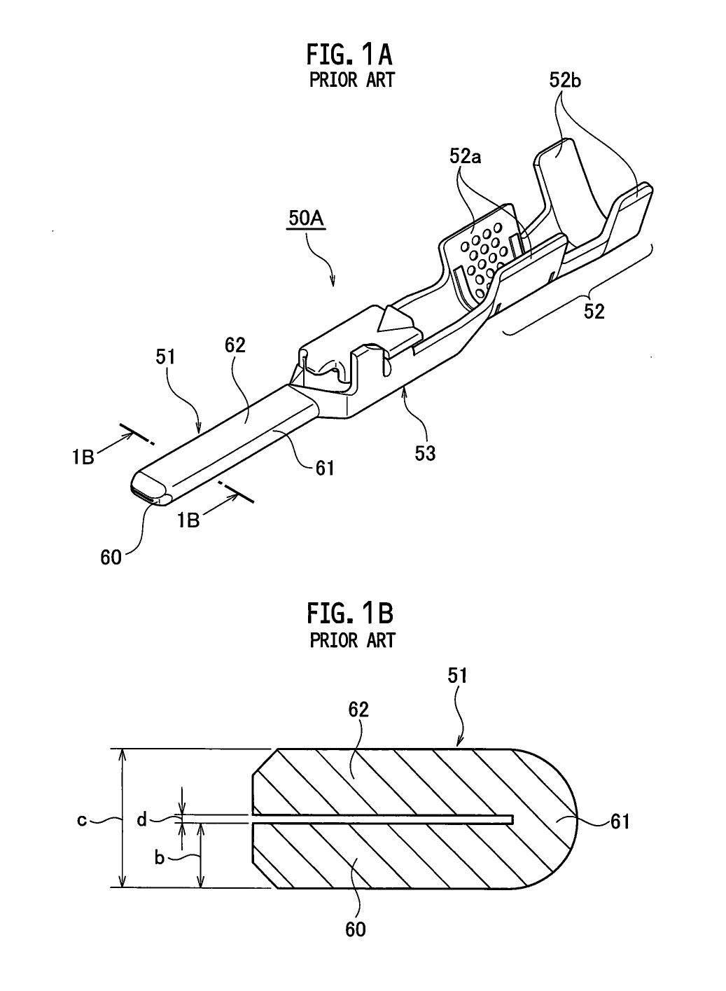

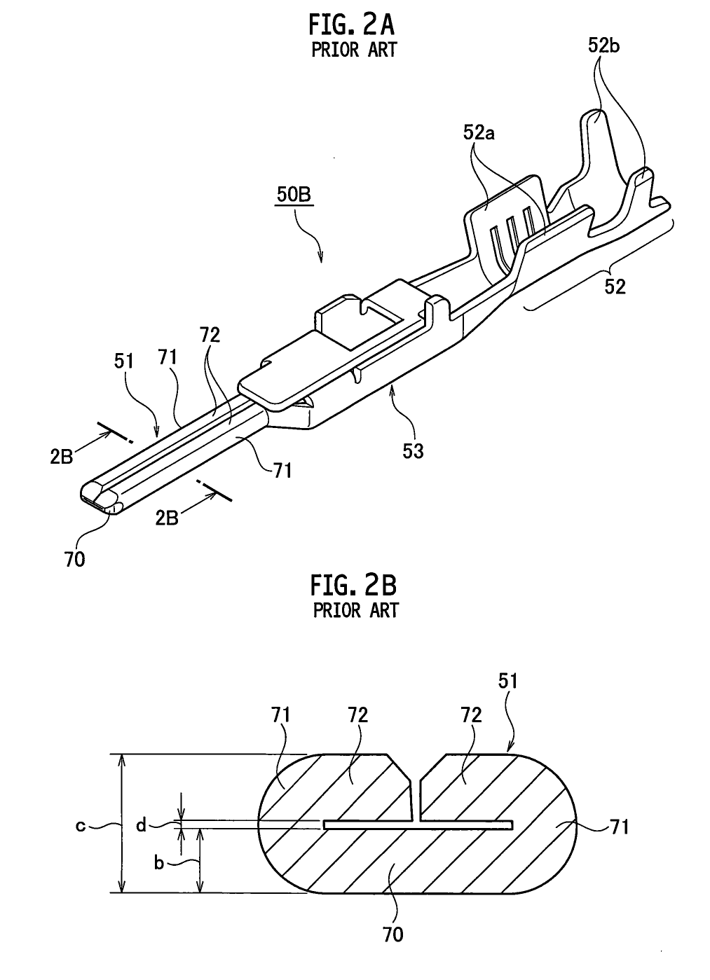

### DESCRIPTION OF EMBODIMENTS

### Embodiment

### Example

Descriptions will be hereinbelow provided for an embodiment of the present invention based on the drawings.

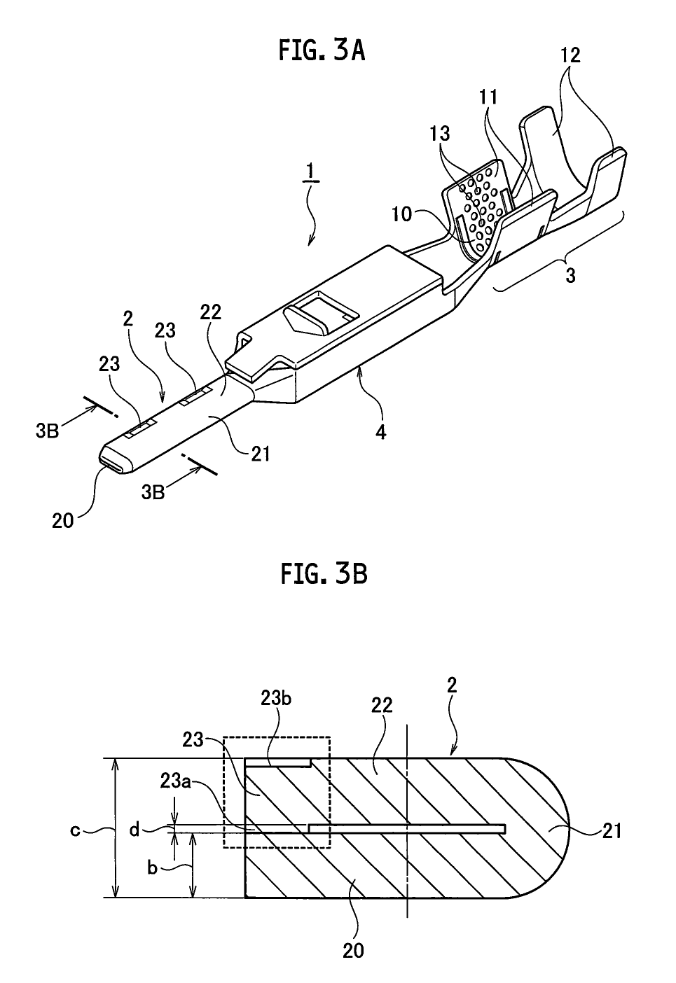

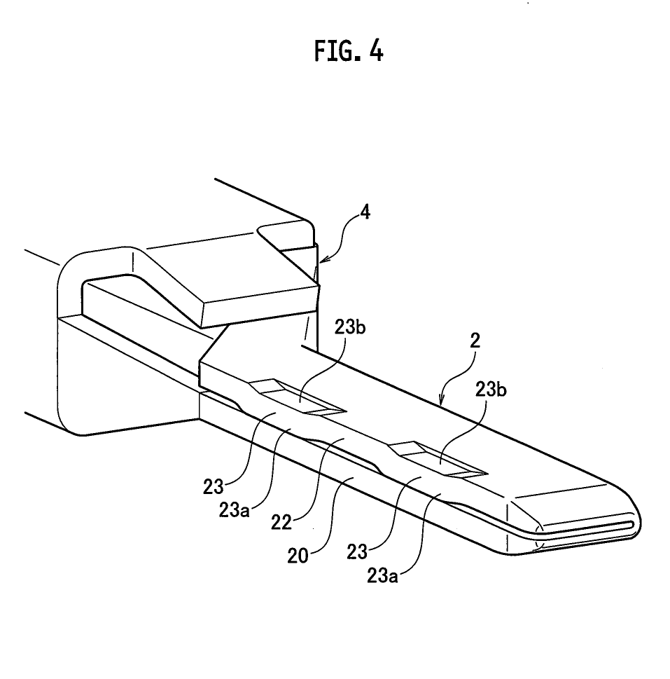

FIGS. 3A, 3B and 4 show the embodiment of the present invention. As shown in FIGS. 3A, 3B and 4, a male terminal 1 is formed by: blanking out a plate-shaped base material of electrically-conductive metal into a predetermined shape; and bending the resultant predetermined-shaped base material. The male terminal 1 includes: a tab portion 2 to be connected to a female terminal (not illustrated); an electrical cable crimping portion 3 to which an electrical cable (not illustrated) is connected; and an intermediate linking portion 4 configured to link the tab portion 2 and the electrical cable crimping portion 3.

The electrical cable crimping portion 3 includes: a base portion 10; a pair of conductor pinching portions 11 respectively extended from the two sides of the base portion 10; and a pair of cover pinching portions 12 extended from the two sides of the base portion 10. Many serrations (locking grooves) 13 each shaped like an arc groove are scatteredly provided on the inner surface of the base portion 10 and the inner surfaces of the pair of conductor pinching portions 11. The conductor of the electrical cable (not illustrated) is exposed by stripping off the cover on the conductor at a terminal portion. In addition, a part of the conductor of the electrical cable and the pair of conductor pinching portions 11 are crimped together by squeezingly deforming the pair of conductor pinching portions 11, while a part of the cover of the electrical cable and the pair of cover pinching portions 12 are crimped together by squeezingly deforming the pair of cover pinching portions 12.

The intermediate linking portion 4 is shaped like a box, which matches a shape for the housing in a terminal housing chamber of a connecter housing (not illustrated). A lance of the connecter housing is locked to the intermediate linking portion 4. While positioned inside the connecter housing, the male terminal 1 is fixed to the connecter housing with the assistance of the intermediate linking portion 4.

As shown in FIG. 3B in detail, the tab portion 2 includes: a first flat plate portion 20; a folded-back portion 21 bent from a side end of the first flat plate portion 20; and a second flat plate portion 22 extended from a side end of the folded-back portion 21, and disposed overlapping the first flat plate portion 20.

Depressedly deformed portions 23, each depressed from outside and projecting inward, are provided in an opposite side end portion of the second flat plate portion 22 from the folded-back portion 21. A projecting portion 23a on an inner surface of each depressedly deformed portion 23 is in contact with the inner surface of the first flat plate portion 20. An amount of projection of the projecting portion 23a of the depressedly deformed portion 23 is set equal to a desired dimension of the clearance d between the first flat plate portion 20 and the second flat plate portion 22. Each depressedly deformed portion 23 is formed by press indenting before the base material is subjected to bending.

The depressedly deformed portions 23 are provided at two places, respectively. The depressedly deformed portions 23 are respectively provided in non-contact areas which remain out of contact with the female terminal when the tab portion is fitted into the female terminal, in more detail, in two places outside a contact area which comes into contact with the female terminal when the tab portion is fitted into the female terminal.

The clearance d of a predetermined dimension (an amount of projection of the projecting portion 23a of each depressedly deformed portion 23) is formed between the first flat plate portion 20 and the second flat plate portion 22 by providing the depressedly deformed portions 23. Thereby, the tab thickness c of the tab portion 2 is set at 2b+d, where b denotes the plate thickness of the base material (the first flat plate portion 20 and the second flat plate portion 22).

As described above, the depressedly deformed portions 23, each depressed from outside and projecting inward, are provided in the opposite side end portion of the second flat plate portion 22 from the folded-back portion 21, and the inner surfaces of the respective depressedly deformed portions 23 are in contact with the first flat plate portion 20. For this reason, the clearance d between the first flat plate portion 20 and the second flat plate portion 22 can be set at an accurate dimension, and the tab thickness c can be accurately set at a desired thickness. Accordingly, it is possible to securely prevent problems which would occur if the tab thickness c were thicker or thinner than the desired thickness. In other words, it is possible to prevent an increase in force needed for insertion into the female terminal (not illustrated), which would occur if the tab thickness c were thicker than the desired thickness. It is possible to prevent a situation where no stable contact condition can be obtain, which would occur if the tab thickness c were thinner than the desired thickness and load of contact with the female terminal (not illustrated) would accordingly become smaller.

Dimensional management of the clearance d is easier than ever, since the forming of the tab portion 2 can be achieved by bending the tab portion 2 until the projecting portions 23a of the depressedly deformed portions 23 of the second flat plate portion 22 come into contact with the inner surface of the first flat plate portion 20. Since the dimensional management of the clearance d is easy to perform as described above, a need to change the plate thickness of the base material can be easily satisfied while keeping the thickness dimension c of the tab portion 2 unchanged.

Since the depressedly deformed portions 23 are provided by deforming the second flat plate portion 22, the provision of the depressedly deformed portions 23 can be achieved by using the base material whose dimension is the same as that of a base material which would be used if no depressedly deformed portions 23 were provided, and thus does not increase material costs. In contrast, if extended portions extended from the side edge of the second flat plate portion 22 were provided and components corresponding to the projecting portions were provided by bending the extended portions, the size of the base material would need to be larger than when no extended portions are provided. The present invention enables the depressedly deformed portions 23 to be formed using the base material in the same size, and accordingly does not increase the material costs.

Since the depressedly deformed portions 23 are provided at the positions in the opposite side end of the second flat plate portion 22 from the folded-back portion 21, the dimension of the clearance d between the first flat plate portion 20 and the second flat plate portion 22 can be set most accurately. In contrast, if the depressedly deformed portions 23 were provided at positions which are closer to the folded-back portion 21 than are the positions in the opposite side end of the second flat plate portion 22 from the folded-back portion 21, the area of the positions in the opposite side end of the second flat plate portion 22 from the folded-back portion 21 would become a free end. For this and other reasons, the dimension is less accurate than when the depressedly deformed portions 23 are provided at the positions on the opposite side end of the second flat plate portion 22 from the folded-back portion 21.

Since the depressedly deformed portions 23 are provided in the non-contact areas which remain out of contact with the female terminal when the tab portion is fitted into the female terminal, the depressed portions 23b of the depressedly deformed portions 23 do not become points of contact with the female terminal. For this reason, problems of an increase in contact resistance and the like do not occur.

Since the depressedly deformed portions 23 are provided in the two respective places outside the contact area which comes into contact with the female terminal when the tab portion is fitted into the female terminal, the tab thickness c of the contact area which comes into contact with the female terminal, and which is located between the two depressedly deformed portions 23, is securely set at the desired thickness.

### [Modifications]

Although in the embodiment, the depressedly deformed portions 23 are provided in the side edge portion of the second flat plate portion 22, the depressedly deformed portions 23 may be instead provided in the side edge of the first flat plate portion 20. Otherwise, the depressedly deformed portions 23 may be provided in both the first flat plate portion 20 and the second flat plate portion 22 in a way that the projecting portions 23a of the depressedly deformed portions 23 in the first flat plate portion 20 come into contact with the projecting portions 23a of the depressedly deformed portions 23 in the second flat plate portion 22. If doing so, the tab thickness c of the tab portion 2 which can be formed without changing the plate thickness b of the base material can be made larger.

The male terminal 1 of the present invention is also applicable to a tab portion with a structure like that of the second conventional example.

### INDUSTRIAL APPLICABILITY

According to an aspect of the present invention, since the clearance between the first flat plate portion and the second flat plate portion can be set at an accurate dimension, and since the tab thickness can be accurately set at a desired thickness, it is possible to securely prevent problems which would occur if the tab thickness were thicker or thinner than the desired thickness.

1. A male terminal comprising a tub portion formed by bending a plate-shaped base material in a folded-back manner, wherein
the tab portion includes
a first flat plate portion,
a folded-back portion bent from a side end of the first flat plate portion, and
a second flat plate portion extended from a side end of the folded-back portion, and overlapping the first flat plate portion,
at least one of the first flat plate portion and the second flat plate portion includes a depressedly deformed portion in an opposite side end portion thereof from the folded-back portion, the depressedly deformed portion depressed from outside and projecting inward, and
a projecting portion on an inner surface of the depressedly deformed portion is in contact with the second flat plate portion or the first flat plate portion.

2. The male terminal according to claim 1,
wherein the depressedly deformed portion is provided in a non-contact area which remains out of contact with a female terminal when the male terminal is fitted into the female terminal.

3. The male terminal according to claim 2,
wherein a plurality of the depressedly deformed portions are respectively provided in both places outside a contact area which comes into contact with the female terminal when the male terminal is fitted into the female terminal.
